(19) United States
(12) Patent Application Publication
(10) Pub. No.: US 2013/0093755 A1
(43) Pub. Date: Apr. 18, 2013

(54) Method For Displaying Stereoscopic Image And Corresponding Stereoscopic Image Displaying Device

(71) Applicants: Hung-lung Hou, Shenzhen City (CN); Cheng-ming He, Shenzhen City (CN)

(72) Inventors: Hung-lung Hou, Shenzhen City (CN); Cheng-ming He, Shenzhen City (CN)

(73) Assignee: Shenzhen China Star Optoelectronics technology Co Ltd., Shenzhen City, Guangdong (CN)

(21) Appl. No.: 13/379,352

(22) PCT Filed: Oct. 26, 2011
(86) PCT No.: PCT/CN11/81303

§ 371 Date: Dec. 19, 2011

(30) Foreign Application Priority Data
Oct. 18, 2011 (CN) 2011103170250

(51) Int. Cl. G09G 3/36; G06T 15/00

(52) U.S. Cl. 345/419; 345/87

(57) ABSTRACT

The present invention discloses a method for displaying stereoscopic image and a stereoscopic image displaying device. The stereoscopic image displaying device includes a display panel, a backlight module, and shutter glasses. The display panel sequentially writes in left-eye image data and right-eye image data. The backlight module is sequentially activated and deactivated in order to scan the left-eye image data and the right-eye image data. The shutter glasses alternately open and shut a left-eye shutter and a right-eye shutter in order to receive the left-eye image data when the left-eye shutter opens to receive the right-eye image data when the right-eye shutter opens. The left-eye image data that are received when the left-eye shutter opens are always image data of first polarity, and the right-eye image data that are received when the right-eye shutter opens are always image data of second polarity. Thus, the left eye of a user always receives image data of the same polarity, and the right eye also always receive image data of the same, opposite polarity, so that the user, when making viewing, does not perceive any flicking phenomenon and the displaying performance is not affected.

### BACKGROUND OF THE INVENTION

1. Field of the Invention

The present invention relates to a method for displaying stereoscopic image and corresponding stereoscopic image displaying device, and in particular to a method for displaying stereoscopic image by using active shutter glasses to view a stereoscopic image and a corresponding stereoscopic image displaying device.

2. The Related Arts

With the progress of technology and science, stereoscopic (or so-call three-dimensional) image displaying devices that viewers to see vivid images are now favored by the general consumers. Currently, the stereoscopic image displaying devices are classified as glasses based stereoscopic displaying devices and glasses-free stereoscopic displaying device. The stereoscopic displaying devices display a left-eye image and a right-eye image, individually, on a display panels and the left-eye image and the right-eye image are then received with polarization glasses or shutter glasses to form a stereoscopic image. The glasses-free stereoscopic displaying device comprises an optic sheet, such as a parallax barrier, which is mounted to display panels to separate left and right parallax images.

For a stereoscopic image displaying device that uses shutter glasses, the left-eye shutter of the shutter glasses opens during the time intervals for odd frames in order to sequentially scan left-eye image data on a display panel; and the right-eye shutter of the shutter glasses opens during the time intervals for even frames in order to scan right-eye image data on the display panel. As such, a user may view a stereoscopic image with the active shutter glasses.

The currently available stereoscopic image displaying devices generally use a liquid crystal display panel as the display panel thereof for displaying the left-eye image data and the right-eye image data. In other words, a regular liquid crystal display panel is used to serve as the display panel for displaying image data. When a stereoscopic displaying device employs DC (Direct Current) voltage to control a liquid crystal layer, electrical charges may easily accumulate on electrodes, leading to residue of voltage and difficult of charging capacitor, and thus affecting the displaying performance of the stereoscopic image displaying device. Thus, to alleviate the above drawbacks, liquid crystal display panels that are driven with AC (Alternate Current) voltages are developed and available.

FIG. 1 is a schematic view illustrating the operation principle of a conventional liquid crystal display panel that is driven by AC voltage. As shown in FIG. 1, the liquid crystal display panel comprises pixels, each having a corresponding pixel potential that is divided into a positive half cycle and a negative half cycle. Within the positive half cycle, the pixel potential is higher than a common potential Vcom, namely the pixel potential having positive polarity; and within the negative half cycle, the pixel potential is lower than the common potential Vcom, namely the pixel potential having negative polarity. A liquid crystal molecule perceives a voltage difference that is a voltage difference between the pixel potential and the common potential Vcom. Thus, it is possible to the level of the common potential Vcom to make the common potential Vcom exactly located between the pixel potential of the positive half cycle and the pixel potential of the negative half cycle, so that the liquid crystal molecule perceives exactly identical voltage difference in both the positive and negative half cycles. Further, since the liquid crystal display device employs a polarity-alternating pixel potential to drive a pixel, accumulation of electrical charge can be eliminated.

However, due to the influence imposed by consistency of a manufacturing process, the pixels formed at different locations on a liquid crystal display panel are of minor differences from each other during the manufacturing process, and this makes the center level between the positive and negative half cycles for each pixel different from each other. However, in making adjustment, it is only possible to carry out adjustment operations on the basis of the center level of a specific one of the pixels for providing a reference common potential. Consequently, it may occur that the center levels of the pixels of other locations are inconsistent with the reference common potential and this leads to a situation that the liquid crystal molecules corresponding to some of the pixels perceive non-identical voltage differences in the positive and negative half cycles, thereby resulting in a flicking phenomenon and thus affecting the displaying performance.

### SUMMARY OF THE INVENTION

The technical issue to be primarily addressed by the present invention is to provide a method for displaying stereoscopic image and a corresponding stereoscopic image displaying device, which allow a viewer to make a viewing without perceiving any flicking phenomenon and do not affect displaying performance.

The present invention provides a method for displaying stereoscopic image, which is for use with a stereoscopic image displaying device. The stereoscopic image displaying device comprises a display panel, a backlight module, and the shutter glasses. The display panel is divided into N display zones, and the backlight module is correspondingly divided into N light source zones, wherein N is an even number. The method for displaying stereoscopic image comprises sequentially writing image data of first polarity into the N display zones; at the time when the image data of first polarity are written to (N/2+1)th display zone, starting to sequentially activate the N light source zones to sequentially scan the image data of first polarity of corresponding display zones and opening the left-eye shutter of the shutter glasses and shutting the right-eye shutter in order to receive the image data of first polarity as left-eye image data; at the time when (N/2+1)th light source zone is activated to scan the image data of first polarity of the (N/2+1)th display zone, starting to sequentially write image data of second polarity to the N display zones; and at the time when the image data of first polarity of the Nth display zone is completely scanned with Nth light source zone being activated, repeating to sequentially the N light source zones to sequentially scan image data of second polarity of the corresponding display zones and shutting the left-eye shutter of the shutter glasses and opening the right-eye shutter to receive the image data of second polarity as right-eye image data.

Preferably, the display panel comprises a liquid crystal the display panel.

Preferably, the first polarity is positive polarity and the second polarity is negative polarity.

The present invention also provides a method for displaying stereoscopic image, which is for use with a stereoscopic image displaying device. The stereoscopic image displaying device comprises a display panel, a backlight module, and shutter glasses. The display panel is divided into a plurality of display zones and the backlight module is correspondingly divided into a plurality of light source zones. The method for displaying stereoscopic image comprises: sequentially writing image data of first polarity into the display zones; sequentially activating the light source zones to sequentially scan the image data of first polarity of the display zones, wherein a starting point for activating the light source zones lags behind a starting point for writing the image data of first polarity into the display zones by a half of a frame period; opening a left-eye shutter of the shutter glasses and shutting a right-eye shutter in order to receive the image data of first polarity as left-eye image data; sequentially writing image data of second polarity into the display zones, wherein the second polarity is opposite to the first polarity; repeating to sequentially activate the light source zones to sequentially scan the image data of second polarity of the display zones, wherein a starting point for activating the light source zones lags behind a starting point for writing the image data of second polarity into the display zones by a half of the frame period; and shutting the left-eye shutter of the shutter glasses and opening the right-eye shutter in order to receive the image data of second polarity as right-eye image data.

Preferably, at the starting point for sequentially activating the light source zones to sequentially scan the image data of first polarity of the display zones, the left-eye shutter of the shutter glasses begins to open and the right-eye shutter begins to shut until the image data of first polarity of the display zones have been completely scanned, in order to synchronously receive the image data of first polarity.

Preferably, the starting point for sequentially writing the image data of second polarity into the display zones lags behind the starting point for sequentially activating the light source zones to sequentially scan the image data of first polarity of the display zones by a half of the frame period.

Preferably, at the starting point for repeating to sequentially activate the light source zones to sequentially scan the image data of second polarity of the display zones, the left-eye shutter of the shutter glasses begins to open and the right-eye shutter begins to shut until the image data of second polarity of the display zones have already been completely scanned in order to synchronously receive the image data of second polarity.

The present invention also provides a stereoscopic image displaying device, which comprises a display panel, a backlight module, and shutter glasses. The display panel sequentially writes in left-eye image data and right-eye image data. The backlight module is sequentially activated and deactivated in order to scan the left-eye image data and the right-eye image data. The shutter glasses alternately open and shut a left-eye shutter and a right-eye shutter in order to receive the left-eye image data when the left-eye shutter opens and to receive the right-eye image data when the right-eye shutter opens. The left-eye image data received when the left-eye shutter opens are completely image data of first polarity, and the right-eye image data received when the right-eye shutter opens are completely image data of second polarity.

Preferably, the display panel is divided into N display zones, and the backlight module is correspondingly divided into N light source zones.

Preferably, the first polarity is positive polarity and the second polarity is negative polarity.

Preferably, the stereoscopic image displaying device comprises a display panel drive circuit, which drives the display panel for writing image data to the display panel.

Preferably, the display panel drive circuit comprises a gate drive circuit and a source drive circuit.

Preferably, the stereoscopic image displaying device comprises a backlight module drive circuit, which drives the backlight module to sequentially activate and deactivate the light source zones of the backlight module.

Preferably, the stereoscopic image displaying device comprises a shutter glasses drive circuit, which drives the shutter glasses to alternately open and shut the left-eye shutter and the right-eye shutter thereof.

In the a stereoscopic image displaying device and the method for displaying stereoscopic image according to the present invention, the left eye of a user always receives image data the same polarity, and the right eye also always receives image data of the same, opposite polarity, whereby the user, when making viewing, does not perceive any flicking phenomenon and thus the displaying performance is not affected.

The above description is only a summary of the technical solution of the present invention. To make the technical solution of the present invention better understood for being reduced to practice according to the disclosure of the specification and to make the above and other objectives, features, and advantages of the present invention easily understood, preferred embodiments will be described in detail as follows, reference being had to the attached drawings.

### BRIEF DESCRIPTION OF THE DRAWINGS

FIG. 1 is a schematic view illustrating the operation principle of a conventional liquid crystal display panel that is driven by alternate voltage;

FIG. 2 is a schematic view showing a stereoscopic image displaying device according to preferred embodiment of the present invention;

FIG. 3 is a first schematic view illustrating operation principle of the stereoscopic image displaying device shown in FIG. 2 for displaying a stereoscopic image;

FIG. 4 is a second schematic view illustrating the operation principle of the stereoscopic image displaying device shown in FIG. 2 for displaying a stereoscopic image;

FIG. 5 is a third schematic view illustrating the operation principle of the stereoscopic image displaying device shown in FIG. 2 for displaying a stereoscopic image;

FIG. 6 is a fourth schematic view illustrating the operation principle of the stereoscopic image displaying device shown in FIG. 2 for displaying a stereoscopic image;

FIG. 7 is a fifth schematic view illustrating the operation principle of the stereoscopic image displaying device shown in FIG. 2 for displaying a stereoscopic image;

FIG. 8 is a sixth schematic view illustrating the operation principle of the stereoscopic image displaying device shown in FIG. 2 for displaying a stereoscopic image;

FIG. 9 is a seventh schematic view illustrating the operation principle of the stereoscopic image displaying device shown in FIG. 2 for displaying a stereoscopic image; and

FIG. 10 is an eighth schematic view illustrating the operation principle of the stereoscopic image displaying device shown in FIG. 2 for displaying a stereoscopic image.

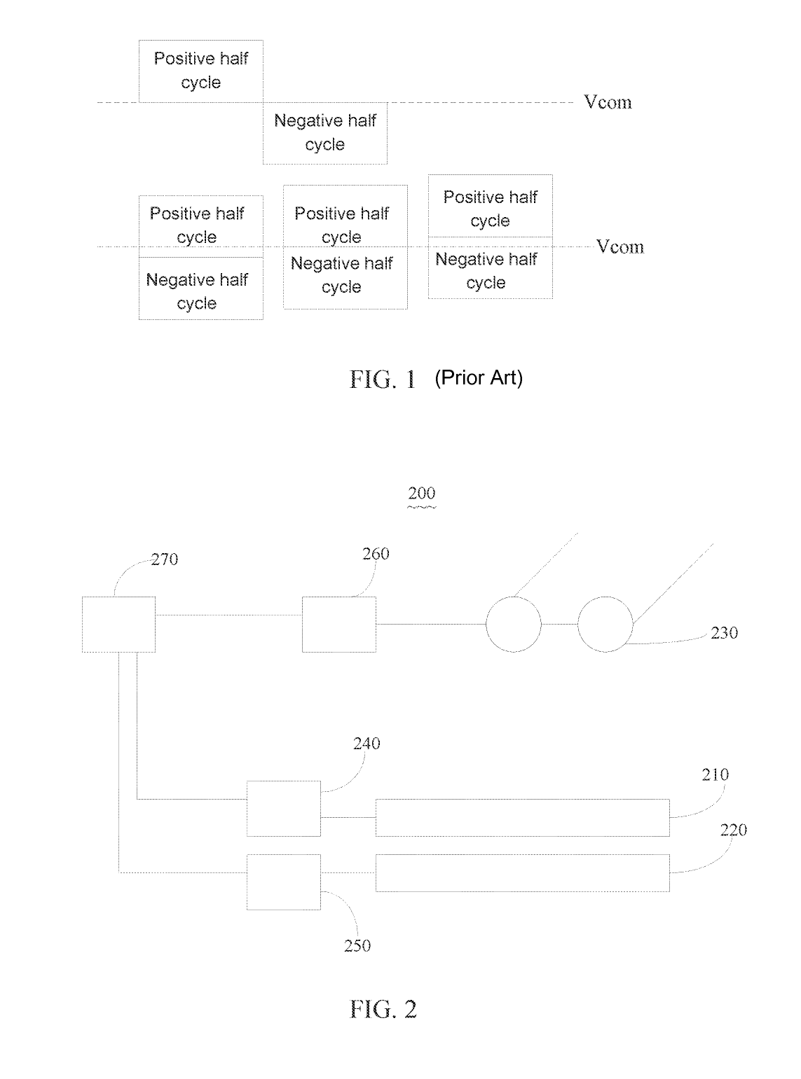

### DETAILED DESCRIPTION OF THE PREFERRED EMBODIMENTS

To expound the technical solution that the present invention adopts to achieve the desired objectives and the efficacies thereof, a detailed description of specific ways, methods, processes, structures, features, and advantages is given below by referring to the attached drawings and preferred embodiments for a method for displaying stereoscopic image and a corresponding stereoscopic image displaying device provided according to the present invention. The above and other technical contents, features, and advantages of the present invention will become apparent by reading the following detailed description of the preferred embodiments with reference to the drawings. With the illustration of the specific embodiments, the technical solution that the present invention adopts to achieve the desired objectives and the advantages thereof can be more deeply and more clearly understood. However, the attached drawings are provided for reference for the purposes of illustration, not intending to impose undue limitation to the present invention.

FIG. 2 is a schematic view showing a stereoscopic image displaying device according to preferred embodiment of the present invention. As shown in FIG. 2, the stereoscopic image displaying device 200 according to the present invention comprises a display panel 210, a backlight module 220, and shutter glasses 230. The display panel 210 can be a liquid crystal display panel for sequentially writing in left-eye image data and the right-eye image data, which is divided into a plurality of display zones, such as N display zones, where N is an even number. The backlight module 220 is correspondingly divided into N light source zones, and sequentially activate and deactivates these light source zones in order to scan, in sequence, the left-eye image data and the right-eye image data. The shutter glasses 230 alternately open and shut a left-eye shutter and a right-eye shutter in order to receive the left-eye image data whereby when the left-eye shutter opens and to receive the right-eye image data when the right-eye shutter opens.

Further, the stereoscopic image displaying device 200 further comprises a display panel drive circuit 240, a backlight module drive circuit 250, a shutter glasses drive circuit 260, and a controller 270. The controller 270 is electrically connected to the display panel drive circuit 240, the backlight module drive circuit 250, and the shutter glasses drive circuit 260 to control these drive circuits. The display panel drive circuit 240 drives the display panel 210 for writing image data to the display panel 210, and comprises a gate drive circuit and a source drive circuit. The backlight module drive circuit 250 drives the backlight module 220 for sequentially activating and deactivating these light source zones of the backlight module 220. The shutter glasses drive circuit 260 drives the shutter glasses 230 to alternately open and shut the left-eye shutter and the right-eye shutter.

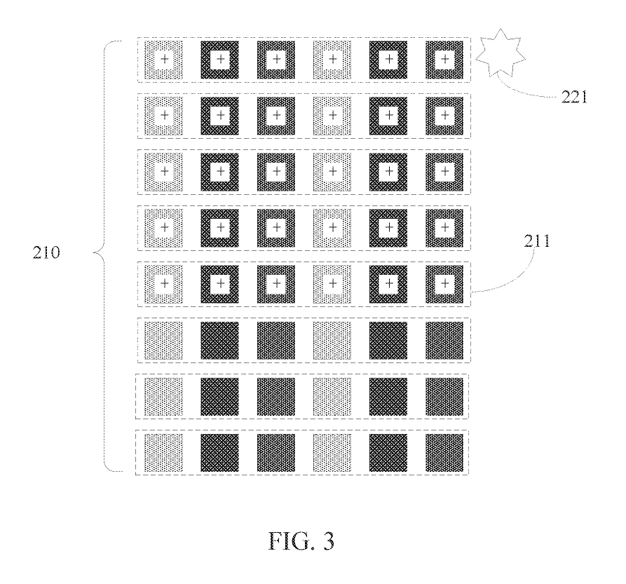

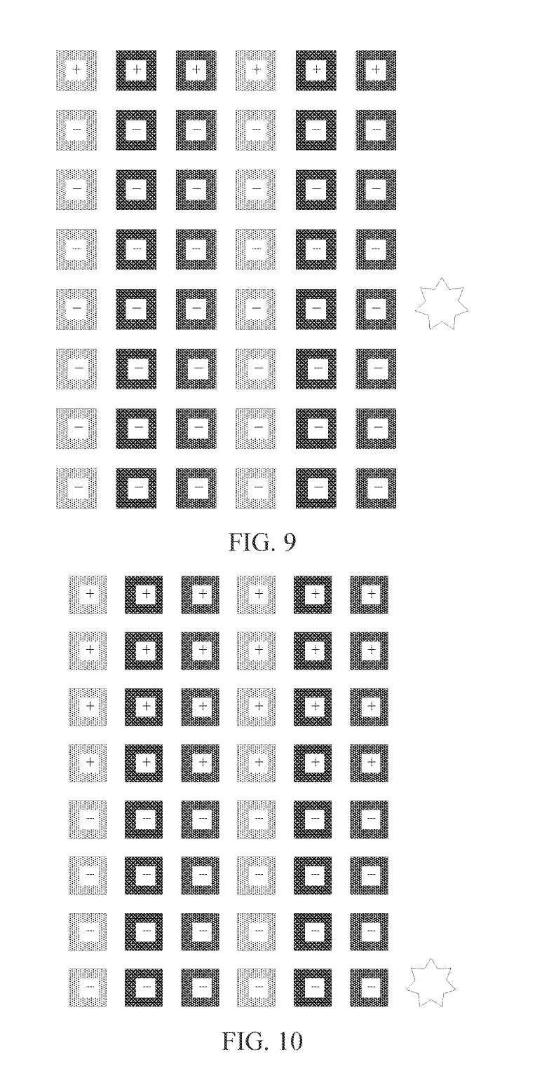

FIGS. 3-10 are schematic views illustrating operation principle of the stereoscopic image displaying device shown in FIG. 2 for displaying a stereoscopic image. As shown in FIG. 3, image data of first polarity are sequentially written into the N display zones 211 of the display panel 210 in turn. In the instant embodiment, explanation of the present invention will be done with an example of eight display zones 211, and the first polarity is positive polarity. When the image data of positive polarity are written into the (N/2+1)th display zone, the N light source zones 221 of the backlight module 220 begin to activate sequentially, in order to sequentially scan the image data of positive polarity of the corresponding display zones 211.

In the instant embodiment, it is that at the time when the image data of positive polarity is written into the fifth display zone, the first light source zone is activated. Since the first display zone corresponding to the first light source zone has already been written with the image data of positive polarity, when the first light source zone is activated, the first display zone is lighted up by light emitting from the first light source zone to thereby display a corresponding image. In other words, the activation of the first light source zone initiates scanning the image data of positive polarity in the first display zone. At this time, the left-eye shutter of the shutter glasses 230 opens, and the right-eye shutter shuts so that the image data of positive polarity of the first display zone is allowed to be received by the left eye of a user.

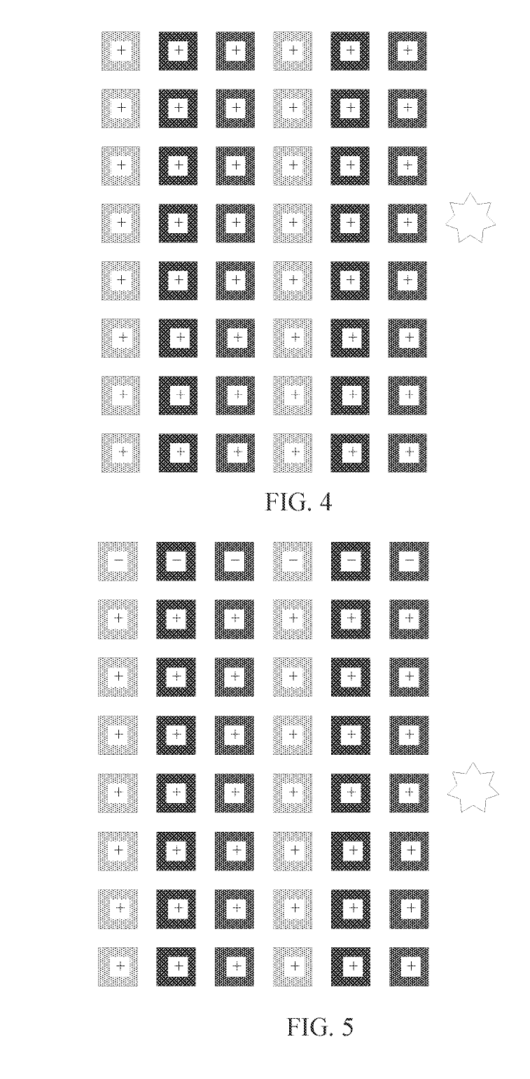

Afterwards, image data of positive polarity are continuously and sequentially written into the remaining display zones, and the light source zones are sequentially activated. As shown in FIG. 4, when the image data of positive polarity is written into the eighth display zone, the fourth light source zone is activated in order to scan the image data of positive polarity written into the corresponding fourth display zone. The shutter glasses 230 continuously maintain the above described condition to sequentially receive the image data of positive polarity for the second to fourth display zones.

Then, as shown in FIG. 5, when the (N/2+1)th light source zone is activated, image data of second polarity begin to sequentially write into the display zones of the display panel 210. In the instant embodiment, when the fifth light source zone is activated, the image data of second polarity are written into the first display zone, and the second polarity can be negative polarity and is opposite to the first polarity. At this moment, the image data of positive polarity written to the first display zone have already been scanned and were received by the left eye of the user, so that writing the image data of negative polarity into the first display zone does not affect viewing by the user.

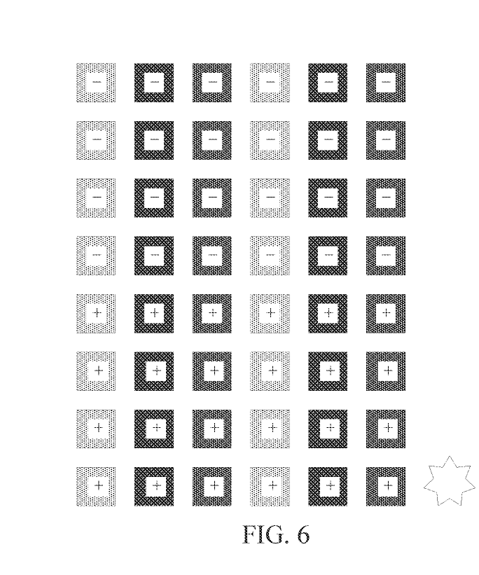

Then, the light source zones are continuously and sequentially activated, and the image data of negative polarity are sequentially written into the display zones. As shown in FIG. 6, when the eighth light source zone is activated, the image data of positive polarity in the eighth display zone are scanned and the shutter glasses 230 maintains the above described condition to sequentially receive the image data of positive polarity of the sixth to eighth display zones. At this moment, the image data of negative polarity are sequentially written into the second to fourth display zones. Thus, the first to eighth light source zones are sequentially activated, and the image data of positive polarity are sequentially received by the left eye of the user so as to have all the image data of positive polarity completely received. Since the image data of positive polarity are sequentially received by the left eye of the user, the image data of positive polarity are treated as the left-eye image data.

Then, when the N light source zones are all activated in sequence, the N light source zones will be repeatedly activated again in sequence. As shown in FIG. 7, the operation returns to repeatedly activate the first light source zone for scanning the first display zone, and at this moment, the image data written to the first display zone are image data of negative polarity. Thus, the first light source zone starts to repeatedly scan the first display zone for the image data of negative polarity. Further, at this moment, the left-eye shutter of the shutter glasses 230 shuts and the right-eye shutter opens in order to receive the image data of negative polarity of the first display zone.

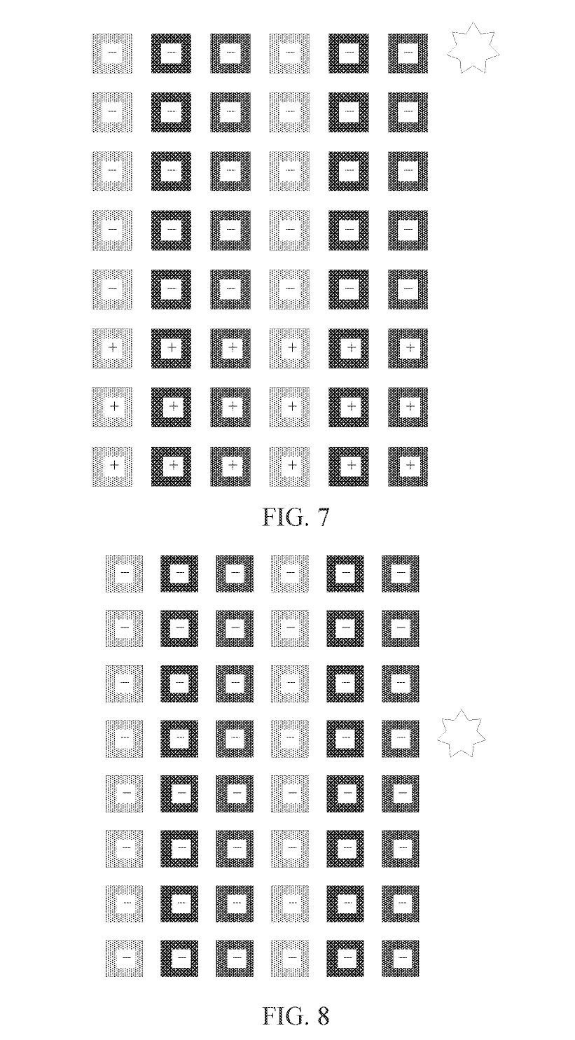

Finally, image data of negative polarity and positive polarity are continuously and sequentially written to the display zones, and the light source zones are sequentially activated until the eighth display zone has already been activated, whereby the right eye of the user is allowed to sequentially receive the image data of negative polarity of the first to eighth display zones to serve as the right-eye image data, and the image data of positive polarity of another frame are sequentially written into a portion of the display zones, as shown in FIGS. 8-10. The above described steps are repeatedly performed to sequentially display the left-eye image data and the right-eye image data on the display panel 210 and the shutter glasses 230 are used to sequentially receive the left-eye image data and the right-eye image data.

Based on the above described operation principle of the stereoscopic image displaying device 200, it is noted that when the left-eye shutter of the shutter glasses 230 opens, the left-eye image data received are always image data of positive polarity; and when the right-eye shutter opens, the right-eye image data received are always the image data of negative polarity. Thus, even the center level is different from the reference common potential for some of the pixels, since the left eye of the user always receive image data of the same polarity and the right eye also always receive image data of the same opposite polarity, the user, when making viewing, does not identify any phenomenon of the center level of a pixel being different from the reference common potential and does not perceive any flicking phenomenon and thus the displaying performance of the stereoscopic image displaying device 200 is affected.

Further, according to the above described operation principle of the stereoscopic image displaying device 200, the time period for sequentially activating the light source zones to scan image data is lagging behind the time period for sequentially writing the image data of a frame into the display zones so that if the time period of writing the image data of a frame into the display zones is defined as a frame period, then the starting point of sequentially activating the light source zones to scan image data lags behind the starting point of writing the image data of a frame into the display zones.

In summary, in the a stereoscopic image displaying device and the method for displaying stereoscopic image according to the present invention, the left eye of a user always receives image data the same polarity, and the right eye also always receives image data of the same, opposite polarity, whereby the user, when making viewing, does not perceive any flicking phenomenon and thus the displaying performance is not affected.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A method for displaying stereoscopic image for use with a stereoscopic image displaying device, the stereoscopic image displaying device comprising a display panel, a backlight module, and the shutter glasses, the display panel being divided into N display zones, the backlight module being correspondingly divided into N light source zones, wherein N is an even number, wherein the method for displaying stereoscopic image comprises:
sequentially writing image data of first polarity into the N display zones;
at the time when the image data of first polarity are written to (N/2+1)th display zone, starting to sequentially activate the N light source zones to sequentially scan the image data of first polarity of corresponding display zones and opening the left-eye shutter of the shutter glasses and shutting the right-eye shutter in order to receive the image data of first polarity as left-eye image data;
at the time when (N/2+1)th light source zone is activated to scan the image data of first polarity of the (N/2+1)th display zone, starting to sequentially write image data of second polarity to the N display zones; and
at the time when the image data of first polarity of the Nth display zone is completely scanned with Nth light source zone being activated, repeating to sequentially the N light source zones to sequentially scan image data of second polarity of the corresponding display zones and shutting the left-eye shutter of the shutter glasses and opening the right-eye shutter to receive the image data of second polarity as right-eye image data.

2. The method for displaying stereoscopic image as claimed in claim 1, wherein the display panel comprises a liquid crystal the display panel.

3. The method for displaying stereoscopic image as claimed in claim 1, wherein the first polarity is positive polarity and the second polarity is negative polarity.

4. A method for displaying stereoscopic image for use with a stereoscopic image displaying device, the stereoscopic image displaying device comprising a display panel, a backlight module, and shutter glasses, the display panel being divided into a plurality of display zones, the backlight module being correspondingly divided into a plurality of light source zones, wherein the method for displaying stereoscopic image comprises:
sequentially writing image data of first polarity into the display zones;
sequentially activating the light source zones to sequentially scan the image data of first polarity of the display zones, wherein a starting point for activating the light source zones lags behind a starting point for writing the image data of first polarity into the display zones by a half of a frame period;
opening a left-eye shutter of the shutter glasses and shutting a right-eye shutter in order to receive the image data of first polarity as left-eye image data;
sequentially writing image data of second polarity into the display zones, wherein the second polarity is opposite to the first polarity;
repeating to sequentially activate the light source zones to sequentially scan the image data of second polarity of the display zones, wherein a starting point for activating the light source zones lags behind a starting point for writing the image data of second polarity into the display zones by a half of the frame period; and
shutting the left-eye shutter of the shutter glasses and opening the right-eye shutter in order to receive the image data of second polarity as right-eye image data.

5. The method for displaying stereoscopic image as claimed in claim 4, wherein at the starting point for sequentially activating the light source zones to sequentially scan the image data of first polarity of the display zones, the left-eye shutter of the shutter glasses begins to open and the right-eye shutter begins to shut until the image data of first polarity of the display zones have been completely scanned, in order to synchronously receive the image data of first polarity.

6. The method for displaying stereoscopic image as claimed in claim 5, wherein the starting point for sequentially writing the image data of second polarity into the display zones lags behind the starting point for sequentially activating the light source zones to sequentially scan the image data of first polarity of the display zones by a half of the frame period.

7. The method for displaying stereoscopic image as claimed in claim 6, wherein at the starting point for repeating to sequentially activate the light source zones to sequentially scan the image data of second polarity of the display zones, the left-eye shutter of the shutter glasses begins to open and the right-eye shutter begins to shut until the image data of second polarity of the display zones have already been completely scanned in order to synchronously receive the image data of second polarity.

8. A stereoscopic image displaying device, wherein the stereoscopic image displaying device comprises:
a display panel, which sequentially writes in left-eye image data and right-eye image data;
a backlight module, which is sequentially activated and deactivated in order to scan the left-eye image data and the right-eye image data; and
shutter glasses, which alternately open and shut a left-eye shutter and a right-eye shutter in order to receive the left-eye image data when the left-eye shutter opens and to receive the right-eye image data when the right-eye shutter opens;
wherein the left-eye image data received when the left-eye shutter opens are completely image data of first polarity, and the right-eye image data received when the right-eye shutter opens are completely image data of second polarity.

9. The stereoscopic image displaying device as claimed in claim 8, wherein the display panel is divided into N display zones, and the backlight module is correspondingly divided into N light source zones.

10. The stereoscopic image displaying device as claimed in claim 8, wherein the first polarity is positive polarity and the second polarity is negative polarity.

11. The stereoscopic image displaying device as claimed in claim 8, wherein the stereoscopic image displaying device further comprises:
a display panel drive circuit, which drives the display panel for writing image data to the display panel.

12. The stereoscopic image displaying device as claimed in claim 11, wherein the display panel drive circuit comprises a gate drive circuit and a source drive circuit.

13. The stereoscopic image displaying device as claimed in claim 8, wherein the stereoscopic image displaying device further comprises:
a backlight module drive circuit, which drives the backlight module to sequentially activate and deactivate the light source zones of the backlight module.

14. The stereoscopic image displaying device as claimed in claim 8, wherein the stereoscopic image displaying device further comprises:
a shutter glasses drive circuit, which drives the shutter glasses to alternately open and shut the left-eye shutter and the right-eye shutter thereof.
